(19) United States
(12) Patent Application Publication
(10) Pub. No.: US 2013/0073934 A1
(43) Pub. Date: Mar. 21, 2013

(54) IMAGE DISPLAY APPARATUS, IMAGE DISPLAY METHOD, AND COMPUTER READABLE MEDIUM

(71) Applicant: Masakazu OGAWA, Kanagawa (JP)

(72) Inventor: Masakazu OGAWA, Kanagawa (JP)

(73) Assignee: FUJI XEROX CO., LTD., Tokyo (JP)

(21) Appl. No.: 13/364,111

(22) Filed: Feb. 1, 2012

(30) Foreign Application Priority Data
Sep. 21, 2011 (JP) 2011-205730

(51) Int. Cl. G06F 17/00

(52) U.S. Cl. 715/204

(57) ABSTRACT

An image display apparatus includes an audio information reproducing unit that reproduces audio information, a document image information reproducing unit that reproduces document image information in synchronization with reproduction time of the audio information, a partitioning unit that partitions the document image information into a plurality of image information segments, an extracting unit that extracts first character-information from each of the plurality of image information segments partitioned by the partitioning unit, a converter unit that converts the audio information into second character-information, a calculator unit that calculates a similarity degree between the first character-information and the second character-information, and a display magnification modifier unit that modifies a display magnification of the document image information, reproduced by the document image information reproducing unit, in response to a region of the image information segment in accordance with the similarity degree calculated by the calculator unit.

### CROSS-REFERENCE TO RELATED APPLICATIONS

This application is based on and claims priority under 35 USC 119 from Japanese Patent Application No. 2011-205730 filed Sep. 21, 2011.

### BACKGROUND

### (i) Technical Field

The present invention relates to an image display apparatus, an image display method, and a computer readable medium.

### SUMMARY

According to an aspect of the invention, there is provided an image display apparatus. The image display apparatus includes an audio information reproducing unit that reproduces audio information, a document image information reproducing unit that reproduces document image information in synchronization with reproduction time of the audio information, a partitioning unit that partitions the document image information into a plurality of image information segments, an extracting unit that extracts first character-information from each of the plurality of image information segments partitioned by the partitioning unit, a converter unit that converts the audio information into second character-information, a calculator unit that calculates a similarity degree between the first character-information and the second character-information, and a display magnification modifier unit that modifies a display magnification of the document image information, reproduced by the document image information reproducing unit, in response to a region of the image information segment in accordance with the similarity degree calculated by the calculator unit.

### BRIEF DESCRIPTION OF THE DRAWINGS

Exemplary embodiments of the present invention will be described in detail based on the following figures, wherein:

FIG. 1 is a block diagram illustrating a configuration of an image display apparatus;

FIG. 2 illustrates an example of synchronization information;

FIG. 3 illustrates an example of a video reproducing operation of the image display apparatus;

FIGS. 4A1 and 4A2 illustrate an operation of a document image partitioning unit;

FIGS. 4B1 and 4B2 illustrate an operation of similarity degree calculation; and

FIG. 5 illustrates a video reproducing operation with a magnification of the image display apparatus modified.

### DETAILED DESCRIPTION

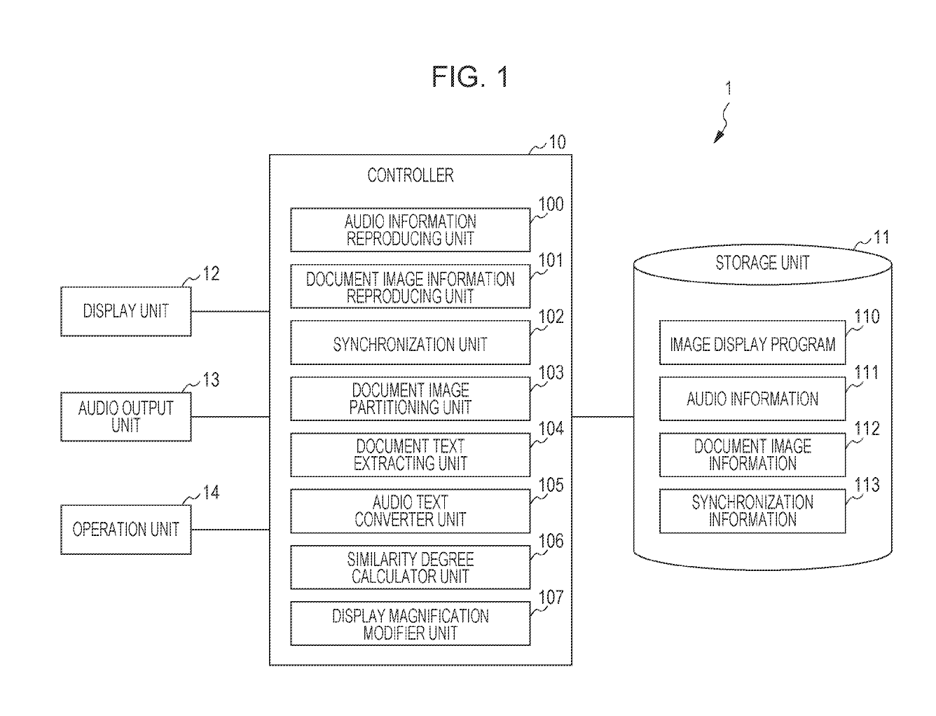

FIG. 1 is a block diagram illustrating a configuration of an image display apparatus 1.

The image display apparatus 1 includes controller 10, storage unit 11, display unit 12, audio output unit 13, and operation unit 14. The controller 10 including a central processing unit (CPU) controls elements of the image display apparatus 1, and executes a variety of programs. The storage unit 11 is a hard disk drive (HDD) or a flash memory, and stores information. The display unit 12 is a liquid-crystal display, for example, and displays characters and images. The audio output unit 13 is one of an audio output terminal and a loudspeaker. The audio output terminal may output an audio signal to an earphone connected thereto. The operation unit 14 generates an operation signal responsive to an operation of a keyboard or a mouse.

The image display apparatus 1 may be an electronic apparatus such as a personal computer, a personal data assistant, or a portable phone. The image display apparatus 1 typically has a display of limited size (for example, with a smaller number of pixels with reference to an image displayed).

The controller 10 executes an image display program 110 to be discussed below, and thus functions as audio information reproducing unit 100, document image information reproducing unit 101, synchronization unit 102, document image partitioning unit 103, document text extracting unit 104, audio text converter unit 105, similarity degree calculator unit 106, and display magnification modifier unit 107.

The audio information reproducing unit 100 reproduces audio information 111, and outputs an audio signal to the audio output unit 13.

The document image information reproducing unit 101 reproduces document image information 112 to be discussed later, and outputs a document image signal. In response to the document image signal, an image reproduced from the document image information 112 is displayed on a display screen of the display unit 12.

Using synchronization information 113 to be discussed below, the synchronization unit 102 synchronizes an audio signal output by the audio information reproducing unit 100 to the document image signal output by the document image information reproducing unit 101.

The document image partitioning unit 103 partitions the document image information 112 into multiple regions (region segments), and generates a segment image from the region segments.

Using an optical character reader (OCR) or the like, the document text extracting unit 104 extracts text information as an example of first character-information from each segment image generated by the document image partitioning unit 103.

The audio text converter unit 105 converts the audio information 111 into text information as second character-information on a per sentence basis.

The similarity degree calculator unit 106 calculates a similarity degree between the text information extracted by the document text extracting unit 104 and the text information converted by the audio text converter unit 105.

Based on the similarity degree calculated by the similarity degree calculator unit 106, the display magnification modifier unit 107 expands or contracts on the region segment an image reproduced by the document image information reproducing unit 101.

The storage unit 11 stores the image display program 110, the audio information 111, the document image information 112, and the synchronization information 113. The image display program 110 causes the controller 10 to operate as the audio information reproducing unit 100 through the display magnification modifier unit 107. The audio information 111 is audio data compressed in lossy compression algorithm or lossless compression algorithm defined by MPEG audio layer 3 (MP3) or RIFF waveform audio format (WAV), or non-compression audio data. The document image information 112 is used to reproduce and display a moving image or a still image. The synchronization information 113 is used to synchronize reproduction time of the audio information 111 to reproduction time of the document image information 112.

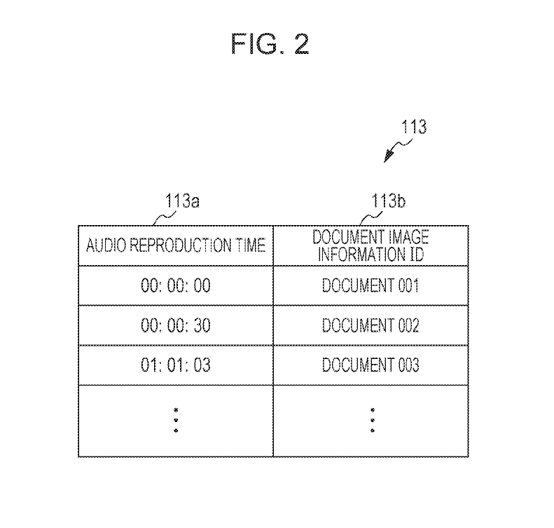

FIG. 2 illustrates an example of the synchronization information 113.

The synchronization information 113 includes an audio reproduction time column 113a listing a reproduction time of the audio information 111, and a document image information ID column 113b listing as a document image information ID an identifier of the document image information 112 that is reproduced at the reproduction time of the audio information 111.

Reproduced is the document image information 112 at the document image information ID column 113b corresponding to the reproduction time of the audio information 111 listed at the audio reproduction time column 113a.

An operation of the image display apparatus 1 is discussed below with reference to FIGS. 1 through 5. The operation of the image display apparatus 1 includes (1) basic process, (2) document image partitioning process, (3) similarity degree calculation process, and (4) magnification modification process.

(1) Basic process

A viewer operates the operation unit 14 in the image display apparatus 1 to instruct the audio information 111 to be reproduced. The operation unit 14 outputs to the controller 10 an operation signal instructing the audio information 111 to be reproduced.

When the controller 10 in the image display apparatus 1 receives the operation signal from the operation unit 14, the audio information reproducing unit 100 reproduces the audio information 111 and outputs an audio signal to the audio output unit 13. The document image information reproducing unit 101 reproduces the document image information 112 and outputs a document image signal to the display unit 12.

In order to synchronize the audio signal to the document image signal in response to the synchronization information 113, the synchronization unit 102 sends a synchronization signal to the audio information reproducing unit 100 and the document image information reproducing unit 101.

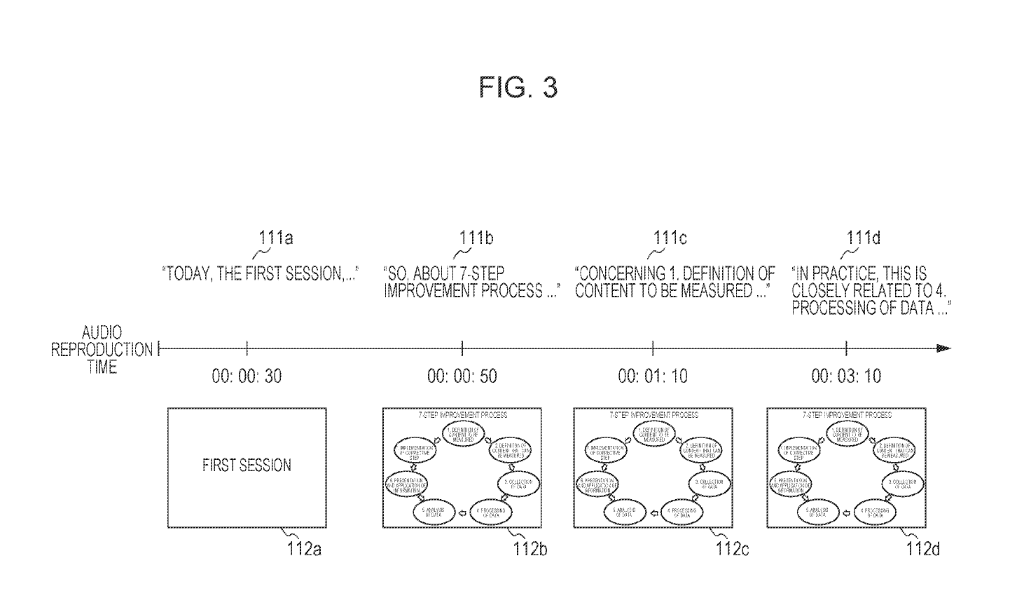

FIG. 3 illustrates an example of a video reproducing process of the image display apparatus 1.

As illustrated in FIG. 3, the audio output unit 13 outputs speeches 111a-111d forming the audio information 111. Based on the synchronization information 113 of FIG. 2, the display unit 12 displays documents 112a-112d at reproduction times of the audio information 111 “00:00:30,” “00:02:01,” “00:05:45,” and “00:15:00.”

If the size of the display unit 12 is small, a visibility problem may arise. The viewer may have difficulty reading the documents 112b-112d. Through the operation discussed below, the display of the documents 112b-112d are expanded in response to the speeches 111a-111d.

### (2) Document Image Partitioning Process

The document image partitioning process of the document image information 112 described below and the similarity degree calculation process described next are typically performed prior to reproducing the audio information 111 and the document image information 112. Alternatively, these processes may be performed when the reproduction of the audio information 111 and the document image information 112 is in progress.

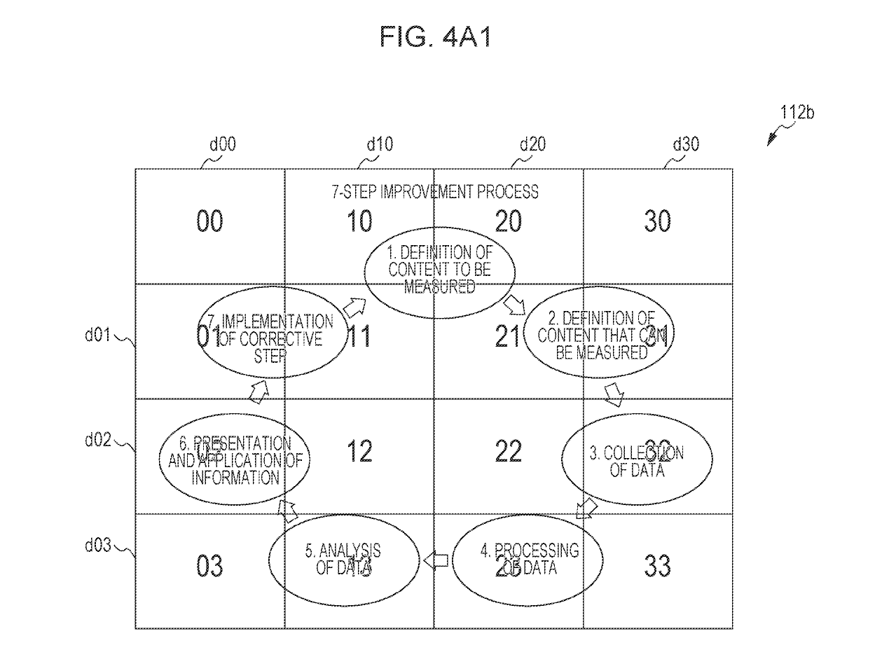

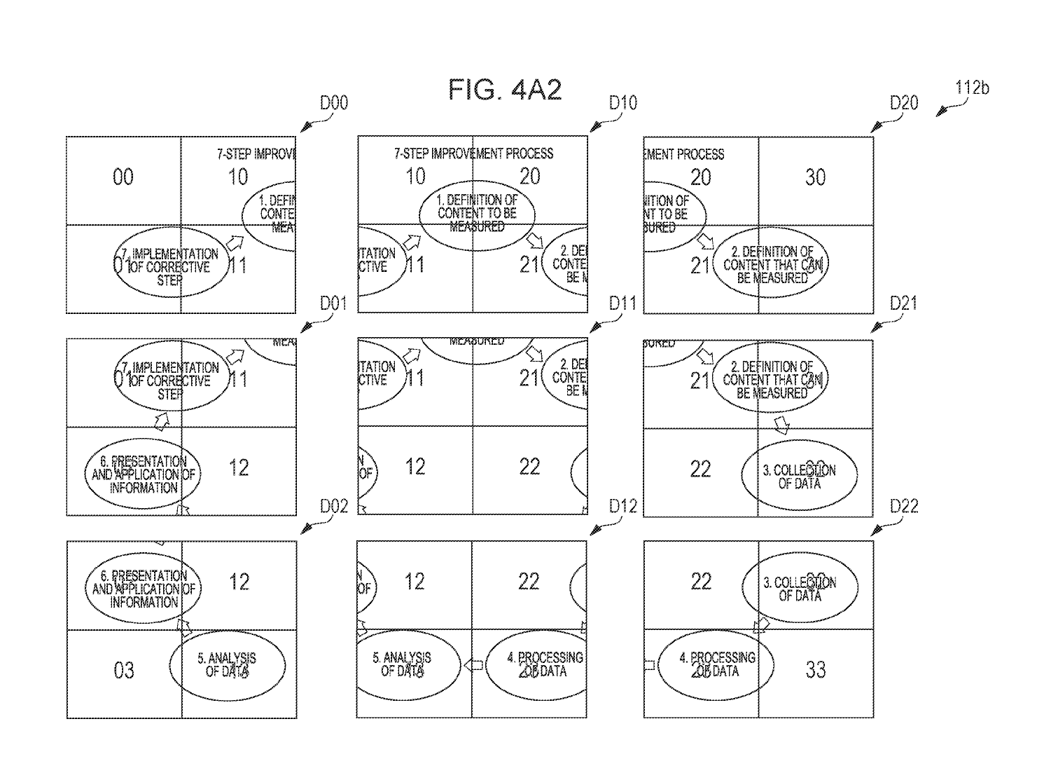

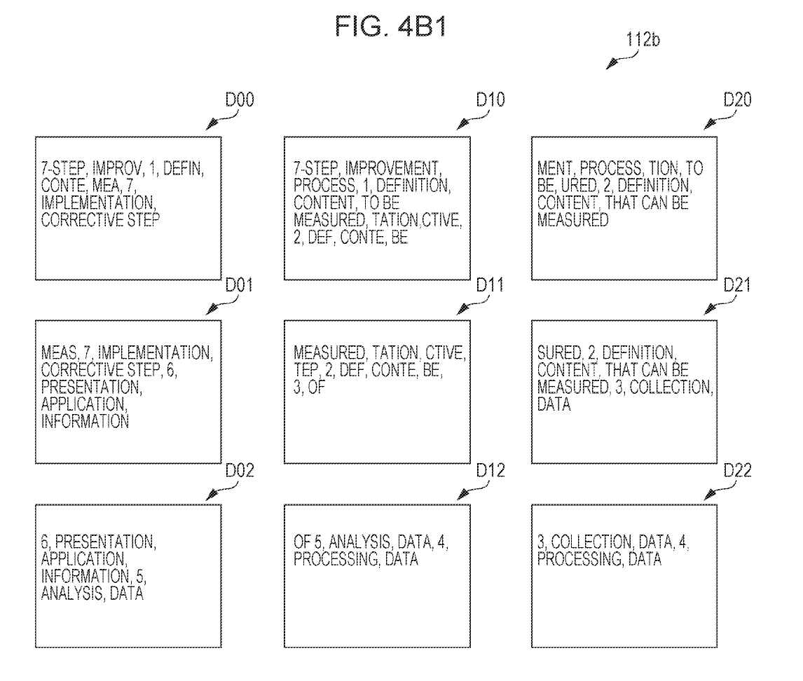

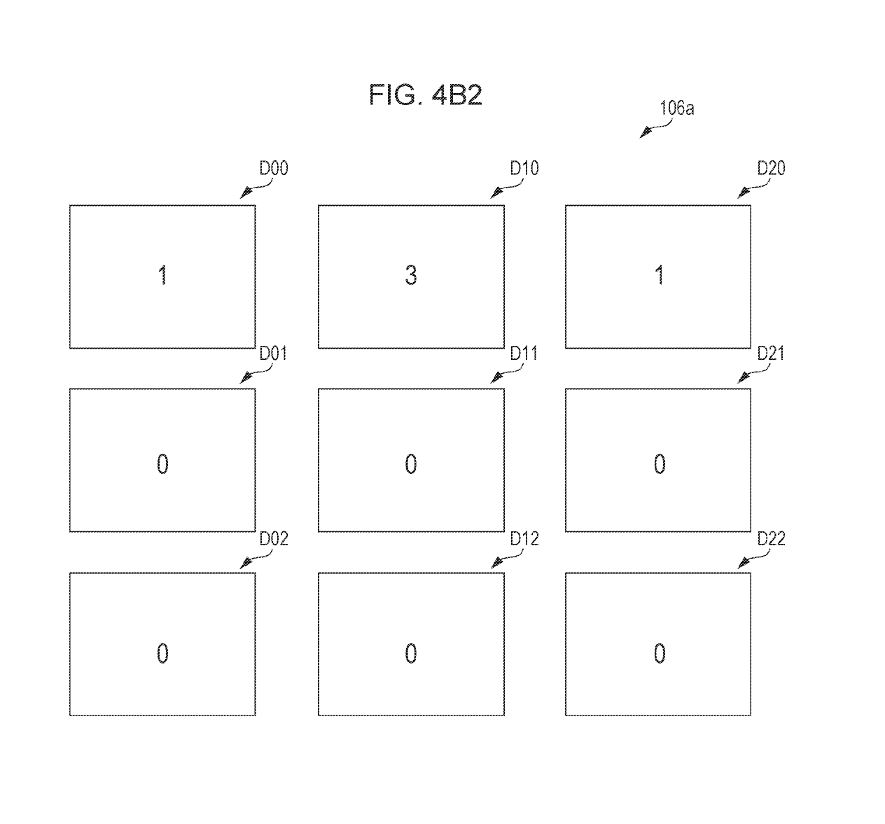

FIGS. 4A1 and 4A2 illustrate the process of the document image partitioning unit 103.

As illustrated in FIG. 4A1, the document image partitioning unit 103 partitions the document 112b into region segments d00-d33. The number of segments may be determined based on the number of characters included in the document 112b, and the font size of the characters. For example, if the number of characters included in the document 112b is large, the number of segments is also set to be large. If the font size is smaller, the number of segments is set to be large. In this way, the visibility of the documents is increased if at least one region segment is expanded and displayed.

The document image partitioning unit 103 generates the segment images D00-D22 from the multiple region segments d00-d33. The segment images D00-D22 are constructed of the region segments such that the adjacent segment images overlap each other. For example, the segment images D00 and D10 overlap each other on the region segments d10 and d11, and the segment images D00 and D01 overlap each other on the region segments d01 and d11. The segment images generated in this way make it less likely for a word having one sense to be split between the segment images.

### (3) Similarity Degree Calculation Process

FIGS. 4B1 and 4B2 illustrate an example of the similarity degree calculation process.

The document text extracting unit 104 extracts text information included in each of the segment images D00-D22 through an OCR or the like as illustrated in FIG. 4B1.

The audio text converter unit 105 converts the speech 111b of FIG. 3 into the text information “So, about 7-step improvement process . . . ” This conversion operation is performed on a per sentence basis of the speech.

The similarity degree calculator unit 106 then calculates a similarity degree between the text information of each of the segment images D00-D22 extracted by the document text extracting unit 104 and the text information converted by the audio text converter unit 105. The similarity degree calculator unit 106 outputs similarity degree calculation results 106a as illustrated in FIG. 4B2. This similarity degree calculation process is also performed on a per sentence basis of the speech.

### (4) Magnification Modification Process

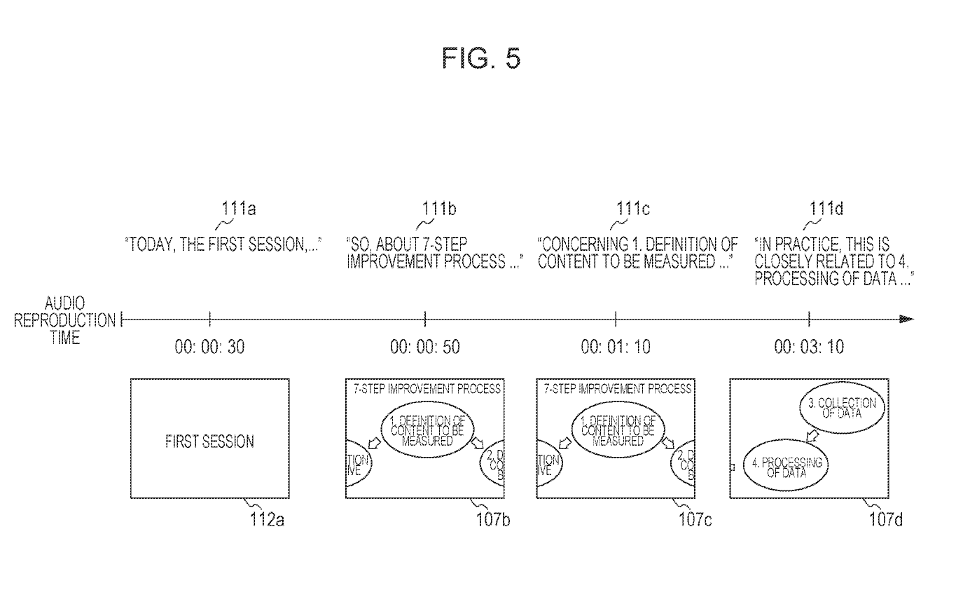

FIG. 5 illustrates an example of the video reproducing process performed with a magnification of the image display apparatus 1 modified.

As illustrated in FIG. 5, the display magnification modifier unit 107 expands the document 112b to be displayed on the display unit 12 onto the segment image D10 having the largest similarity degree in accordance with the similarity degree calculation results 106a and then displays the document 112b as an expansion display 107b on the display unit 12. The other documents 112c and 112d are also expanded and displayed as expansion displays 107c and 107d as described above.

The invention is not limited the embodiment, and a variety of modifications is possible without departing from the scope of the invention. For example, the document image information is expanded or contracted depending on the content of the audio information. Alternatively, the document image information may be expanded or contracted depending on the content of the video information. The document image information is not only expanded or contracted, but also may be changed in shape, rotated, high-light displayed, or displayed in a different color tone.

The document text extracting unit 104 extracts the text information after the document image partitioning unit 103 partitions the document image information 112. Alternatively, the document image partitioning unit 103 may partition the image after the document text extracting unit 104 extracts the text information from the document image information 112 prior to partitioning.

The image display program 110 may be supplied in a stored state on a recording medium such as a compact-disk read-only memory (CD-ROM). Alternatively, the image display program 110 may be downloaded to the image display apparatus 1 from a server apparatus connected to a network like the Internet. Part or whole of the audio information reproducing unit 100, the synchronization unit 102, the document image partitioning unit 103, the document text extracting unit 104, the audio text converter unit 105, the similarity degree calculator unit 106 and the display magnification modifier unit 107 may be implemented in a hardware configuration using application-specific integrated circuit (ASIC) or the like. The steps described with reference to the embodiment may be performed in an order different from the order described above. One of the steps may be omitted, or a new step may be added to the steps.

The functions of the units 100 through 107 in the controller 10 are implemented using the program in the embodiment. Part or whole of the units 100 through 107 may be implemented in a hardware configuration using an ASIC or the like. The program in the embodiment may be supplied in a stored state on the recording medium such as CD-ROM. Steps of the embodiment may be interchanged, deleted, or added without departing from the scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image display apparatus, comprising:
an audio information reproducing unit that reproduces audio information;
a document image information reproducing unit that reproduces document image information in synchronization with reproduction time of the audio information;
a partitioning unit that partitions the document image information into a plurality of image information segments;
an extracting unit that extracts first character-information from each of the plurality of image information segments partitioned by the partitioning unit;
a converter unit that converts the audio information into second character-information;
a calculator unit that calculates a similarity degree between the first character-information and the second character-information; and
a display magnification modifier unit that modifies a display magnification of the document image information, reproduced by the document image information reproducing unit, in response to a region of the image information segment in accordance with the similarity degree calculated by the calculator unit.

2. The image display apparatus according to claim 1, wherein the partitioning unit partitions the document image information such that the image information segments adjacent to each other partially overlap each other.

3. The image display apparatus according to claim 1, wherein the partitioning unit determines a size of the image information segment depending on at least one of a size of, a character count of and a font of characters of the first character-information.

4. An image display method comprising:
reproducing audio information;
reproducing document image information in synchronization with reproduction time of the audio information;
partitioning the document image information into a plurality of image information segments;
extracting first character-information from each of the plurality of partitioned image information segments;
converting the audio information into second character-information;
calculating a similarity degree between the first character-information and the second character-information; and
modifying a display magnification of the reproduced document image information in response to a region of the image information segment in accordance with the calculated similarity degree.

5. A computer readable medium storing a program causing a computer to execute a process for displaying an image, the process comprising:
reproducing audio information;
reproducing document image information in synchronization with reproduction time of the audio information;
partitioning the document image information into a plurality of image information segments;
extracting first character-information from each of the plurality of partitioned image information segments;
converting the audio information into second character-information;
calculating a similarity degree between the first character-information and the second character-information; and
modifying a display magnification of the reproduced document image information in response to a region of the image information segment in accordance with the calculated similarity degree.
